(19) United States
(12) Patent Application Publication
(10) Pub. No.: US 2007/0088774 A1
(43) Pub. Date: Apr. 19, 2007

(54) Computer technical solution of mixed q-nary and carry line digital engineering method

(76) Inventors: Zhizhong Li, Zhejiang Province (CN); Juyuan Xu, Zhejiang Province (CN)

Correspondence Address: BEYER WEAVER LLP, P.O. BOX 70250, OAKLAND, CA, 94612-0250, US

(21) Appl. No.: 10/553,577

(22) PCT Filed: Apr. 19, 2004
(86) PCT No.: PCT/CN04/00375

§ 371 Date: Jun. 30, 2006

(30) Foreign Application Priority Data
Apr. 17, 2003 (CN) 03122702.3
Sep. 27, 2003 (CN) 03143358.8

(51) Int. Cl. G06F 7/50

(52) U.S. Cl. 708/700

(57) ABSTRACT

The present invention relates to the field of digital engineering method and processor, and puts forward a new digital engineering method, which could increase the operation speed. The mixed Q-nary carry line digital engineering method of the present invention includes: adding a numeral sign to each bit of numeral of the common Q-nary numerals that participate in the operation, the numerals that participate in the operation are k mixed Q-nary numerals, and addition operation of mixed Q-nary is performed on the k numerals at the same time, which starts from the lowest bit, and then the “sum by bit” is obtained. Said sum is taken into the next operation layer as the “partial sum” numeral, meanwhile, the “mixed numeral scale” obtained is stored in the high bit adjacent to said bit in any carry line of the next operation layer. Performing such operation until no “mixed Q-nary” is produced, then the sum obtained by the last “adding by bit” is the result of the addition operation. The present invention provides mixed Q-nary, carry line processor.

### TECHNICAL FIELD

The present invention relates to the field of digital engineering and processor, in particular to the arithmetic unit of the processor.

### BACKGROUND ART

The four arithmetic operations are the basic operations of numerals. As Engels has said, “arithmetic (is the essential of all mathematics)”, and addition is the most basic operation in the four arithmetic operations. Therefore, we should certainly put particular attention on the four arithmetic operations, especially the addition operation. The mathematical four arithmetic operations in the current computers, first of all the addition operations, are not quite satisfactory, the major deficiencies are that the speed of operation is slow and in subtraction, the negatives are not brought to their full play, meanwhile, successive subtraction cannot be done. Especially in the mixed operation of addition and subtraction, the operations cannot be finished in a single step; in multiplication, the deficiencies of addition expand and become more serious; in division, the above-mentioned deficiencies exist, too. In summary, in the smallest mathematical entity-the rational number entity, the situation of the four arithmetic operations is not satisfactory.

In digital engineering method, in particular in the mathematical textbooks of high school and elementary school, there are a lot of numerical value operations. Dissection of the operation shows that some connotative operation procedures exist, thus causing some “hidden trouble”. Take addition as an example, example one is that “two numerals are added”, and the arithmetic formula is as formula 1, wherein the sum at the ten's place is 3, and the micro program operation is as followings in a dissection:

| | |
|---|---|
| 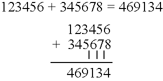 | 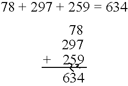 |
| formula 1 | formula 2 |

\textcircled{a} a carry from the units place (see the mark)
\textcircled{b} the two tens places 5 and 7 are added to the carry of the lower place, i.e., (5+7+1), and the units place of the sum is taken
\textcircled{c} the carry of the sum of (5+7+1) is sent to the higher place (see the mark), and the rest of the places have the similar situation.

Another example is as example 2, wherein three numbers are to be added to get the sum, and the formula thereof is as formula 2:
78+297+295=634

As shown in the figure, the above-mentioned deficiencies are more serious.

It is obvious that the following deficiencies exist:

a. It is difficult to mark the carry. If numerals of smaller size are used to indicate it, it is liable to cause a confusion and the area of the numeral is limited. In particular, the situation is more annoying when 456789 is to be represented, because if the “.” is written between the numerals, it is liable to be mixed up with a decimal, and it is inconvenient to represent 456789; if fingers are used to count the numbers, it is slow and inconvenient; if mental calculation is performed, it is a hard mental work and mistakes usually occur.

b. Usually when two numerals are added, there will be three numerals at each place to be added for a sum, so there is the need for a second operation, but when three or more numerals are to be added for a sum, it becomes more inconvenient.

c. It is difficult to check the computations. The operation is usually performed once again, so it is time-consuming and labor-consuming.

(2) Subtraction is more troublesome than addition, and “successive subtraction” within the same vertical formula is impossible, so it must be separated; especially in the mixed operation of addition and subtraction, the operation cannot be finished in a single step.

(3) In multiplication, this problem is more serious, besides, the formats for the operations of addition, subtraction, multiplication and division are not uniform, and a different format is used for division.

On the other hand, in digital engineering using computer, there are also a lot of numerical value operations, and these numerals are usually represented by the common binary system {=}, and the negatives are usually represented by original code, radix-minus-one complement, complement, and frame shift, etc. In the current computers, operations are all carried out by two numerals, and “multi-layer operations” cannot be realized. The so-called “multi-layer operations” mean that more than two numerals are added or subtracted at the same time.

In the computers that adopt other common systems like {Q}, etc., a lot of corresponding complexities exist.

### CONTENTS OF THE INVENTION

The present invention put forward a new digital engineering method which could increase the operation speed and enhance the guarantee for the correctness of the computation, thereby the possibility of making mistakes is notably reduced.

Another object of the present invention is to provide a new processor which could greatly increase the operation speed of the computer on the basis of the current manufacturing technique and in the situation of similar numbers of equipment.

According to one aspect of the present invention, a mixed Q-nary and carry line digital engineering method is provided, which includes the following steps:

the first step, add a numeral sign to each bit of numeral of the common Q-nary numerals that participate in the operation, i.e., indicating if said bit of numeral is positive or negative, so as to make it become a mixed Q-nary numeral, suppose that the numerals that participate in the operation are k mixed Q-nary numerals:

the second step, perform a sum operation for the k numerals at the same time, the operation starts from the lowest bit, and the numerals are added by bit, that is, at a certain bit, two numerals in said k numerals are taken to be added by bit, and a “sum by bit” is obtained, which is the sum of operation layer as the “partial sum” numeral, meanwhile, the obtained “mixed numeral scale” is stored at the higher bit adjacent to said bit in any carry line in the next operation layer;

the third step, chose other two numerals among the k numerals at said bit to perform the second step of operation, and repeat these steps until the k numerals are all taken; when there is only one numeral of the k numerals left, it is directly moved to the same bit at the next operation layer as the “partial sum” numeral;

the fourth step, at a higher bit adjacent to the above-mentioned certain bit, the operations of the second and third steps are repeated until all the operations of each bit of the k operational numerals are finished;

the fifth step, in the next operation layer, an operation for the sum as described in the previous second, third and fourth steps is performed for said “sum by bit” numeral and the “carry numeral” in the carry line;

the operations of the second to the fifth steps are repeated until no “mixed Q-nary” is produced, then the sum obtained in the last “adding by bit” is the result of the addition.

According to another aspect of the present invention, a mixed Q-nary and carry line processor is provided, which comprises input logic, K-layer arithmetic unit, output and conversion logic and controller; the mixed Q scale numeral shift register inputs logic to the K-layer arithmetic unit; in the K-layer arithmetic unit, a mixed Q-nary numeral result is obtained for the mixed Q-nary numeral after the K-layer operations, which is output by the output logic through the decoder output transformation logic in the form of Q-nary numeral or mixed Q-nary numeral, or common decimal numeral, the controller coordinates and controls the logic of the entire operation controller; wherein,

each bit of each register of the 2K registers is assigned with a sign bit, said sign bit is a common two-state trigger; the former K registers store the inputted K mixed Q-nary numerals, while the latter K registers form the K carry lines;

during operation, a certain bit of two registers obtains the sum thereof and the carry for the high bit after the accumulator accumulates them, and the carry is sent to the adjacent higher bit of any carry register; when the next operation command comes, the carry line and the originally stored numerals are sent to the accumulator to be added;

such processes are repeated and finally the sum is obtained by the accumulator.

### DESCRIPTION OF FIGURES (THE MIXED BINARY SYSTEM IS TAKEN AS AN EXAMPLE)

FIG. 1 is the general logic block diagram of the mixed Q-nary computer

FIG. 2 is the logic block diagram of the operation control;

FIG. 3 is the logic block diagram of one bit of the K-layer arithmetic unit;

FIG. 4 is logic block diagram of the counterpart scratching logic (counterpart scratcher);

FIG. 5 is the logic block diagram of the scratching Q logic (Q-scratcher).

### PREFERRED EMBODIMENTS

1. □Method of Carry Lined□

1.1 □Carry and Method of Carry Line□

In computers, one of the keys of increasing the operation speed is “carry”. The acquiring and storing of the carry and the participation of the carry in the operation are crucial. “Carry” is competing for “speed”. In written calculations, it directly affects the “error rate”.

The so-called □Method of carry line□is the method that during the operation process, the generated carry is stored in the position that participates in the operation, and then operation is directly performed. Generally, the carries in different places of the same operation layer are arranged in a line that is called the “carry line”. (The concept of “operation layer will be explained in the next section).

An example is given as follows, wherein it is supposed that two common decimal numerals are added for the sum, and the formula for the sum is a vertical formula, as shown in

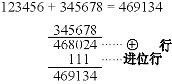

For simplicity, the horizontal formula and the vertical formula are combined herein. The units place operation is (6+8)=14, and the carry 1 thereof is written in the higher bit of the next line, and so on.

When two numerals are added in the formula, the summing at each bit without taking into account the carry is called “adding by bit”, and the sum thereof is called “sum by bit”, and the operation line of the sum by bit is called “⊕ line”.

The line of carries is called “carry line”, and the “operation layer” is formed by the “⊕ line and the carry line.

Some “+” in the formula are omitted. It can be seen later in the □mixed carry method HJF□ that each of the “operation layers” has only one operation, which is “+”, so it is unnecessary to write the “+” in the operation layers.

1.2 Analysis of the□Method of Carry Line□

1.2.1 Analysis of Adding Two Numerals for the Sum

It can be seen from the above section that in the addition that adopts the □Method of carry line□that

□ when two numerals are added, there are only two numerals to be added at each bit, and it is not possible to have more than two numerals to be added at each bit;

□ there is no difficulty to directly mark the carry in the carry line;

□ it is very convenient to check the computation.

[Lemma 1] when two numerals are added, there is either a carry marked as 1 bit or no carry marked as 0 at a random;

[Lemma 2] when two numerals are added, the ⊕ sum at a random bit could be one of 0˜9, but when there is a carry to the higher bit at said bit, the ⊕ sum at said bit can only be one of 0˜8, and it cannot be 9.

It can be obtained from [Lemma 1] and [Lemma 2] that

[Theorem 1] when two numerals are added, the ⊕ sum at a certain bit can be 9 if and only if said bit does not have carry to a higher bit.

1.2.2 The Concept of Layer and Operation Layer

Suppose that two numerals are to be added for the sum, and the formulae are formula 4 and formula 5:

| | |
|---|---|
| 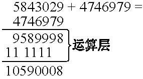 | 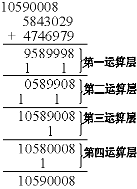 |
| formula 5 | formula 4 |

It can be seen from formula 4 that the operations are carried out by layering, and only one simple operation is performed in each operation layer.

This is the concept of operation “layer”, and the operation layer decomposes one operation into micro-operations and sub-operations.

The concept of “layer” is a basic concept in mathematics. The □Method of carry line□is just based on said concept. The addition operation methods before also contain an implicit concept of “layer” in substance, so the “layer” in the □Method of carry line□ does not increase the complexity of the operation in general. On the contrary, the methods before imply the “layer”, so the complexity of operations is increased, which further causes the speed of operations to be slowed down notably. It is very obvious when said two methods are compared.

In the□Method of carry line□, the layers in which two numerals are added could be combined into one layer, as shown in formula 5. Further analysis thereof could be found in the following texts.

1.2.3 The Unique Operation Layer

When two numerals are added, multiple layers of operation may occur in some special cases, and the following relations are true in the layers.

[Lemma 3] when two numerals are added, if the operation layer prior to some bit has a carry, no carry will occur in the following operation layers (this is obtained from lemma 1 and lemma 2).

[Lemma 4] when two numerals are added, if the operation layer after some bit has a carry, it is certain that no carry exist in the previous operation layers (this is obtained from lemma 1 and lemma 2).

[Theorem 2] when two numerals are added, there is either none carry or only one carry in each layer of the same bit. (This is obtained from lemma 3 and lemma 4.)

[Deduction] the carry lines of all the layers could be combined into one carry line, and all the operation layers could be combined into one operation layer. (The carry that does not belong to the first operation layer could also be marked by a small circle, as shown in formula 5.)

| | |
|---|---|
| 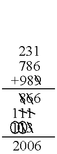 | 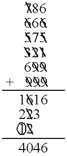 |
| formula 6 | formula 7 |

1.2.4 Analysis of Adding Three Numerals or More for the Sum

Suppose that three numerals are added for the sum, and the formula is 231+786+989=2006 (see formula 6)

Keys of Operation

□ the application of “scratching ten”

The so-called “scratching Q” is that when two numerals of Q carry are added at a certain bit, the sum of adding by bit is zero, but a carry is generated at said bit (which is of the same sign as said two numerals), then the carry is put to the carry line and meanwhile, said two numerals do not participate in the operation at said certain bit.

In decimal system, it is “scratching ten”, and the detailed explanations are as follows:

a. When the sum of two numerals at the same bit is “ten”, said two numerals could be scratched out by a backlash in the formula, then a “1” is added at the higher bit.

b. When the sum of several numerals at the same bit is 20, 30, 40 . . . said numerals could all be scratched out, then “2”, “3”, ‘4”. . . could be added to the higher bit.

Further, it is supposed that six numerals are added for the sum, and the formula is 786+666+575+321+699+999=2046 (see formula 7).

□ when a plurality of numerals are added, two or more operation layers will occur. In order to reduce the number of operation layers, in the empty bit of the same operation layer at the same bit, the carry and ⊕ bit numeral could take any bit.

□ The number of operation layers is reduced as much as possible.

a. Smaller numerals are directly combined to be computed;

b. Carry is performed in “matched pairs” as much as possible;

c. The number of numerals to be added in the first operation layer is reduced as much as possible, and the second or higher operation layer are made not to be appearing as much as possible.

□ “Partial sum” could be directly obtained for the “same numerals”, “successive numerals”, etc. at the same bit.

□ Suppose that m numerals are to be added for the sum, (m is a natural number, m≧2), and the total operation layers is represented by n (n is non-negative integer), then:
nₘᵢₙ=0 (generally n=0, 1, 2, but it is most common that n=1)
nₘₐₓ=m/2, m is even number
m+½, m is odd number formula 8

2. Mixed Numeral and Mixed Numerical System

2.1 □Theory of Numerical System□

2.1.1 The system of recording numerals according to the same rule so as to facilitate operations in a numerical system is called “the system of number representation system”, and “numerical system” for short. The nature of a numeral is first of all decided by the numerical system to which it belongs. Engels has said that “single numeral has had a certain nature in the number representation method, and the nature is decided by such number representation method”.

□Theory of numerical system□is a science that studies the generation, classification, analysis, comparison, transformation, etc. of the numerical system and the application of numerals in the adjacent fields and practices. It is one of the fundamental theories of mathematics.

Numerical system is the characteristic of numerals. There is no numeral that does not have a corresponding numerical system, and there is also no numerical system that does not have the corresponding numerals. [All the numerals whose numerical system is not indicated in this text are common decimal numerals, and the same below.]

2.1.2 Bit Value Numerical System

Suppose that the numerals that construct a number system are represented by “numerical symbols” at different positions. “Numerical symbols” are also called “numerals” which are usually arranged horizontally from right to left, and the corresponding numerical values are arranged from low (small) to high (large). The numeral at each numerical place is assigned with a unit value (which is also called “bit value”), thereby to indicate that the numerical system of each numeral in the whole number system is invariable, and this is called “bit value numerical system”.

The numerical systems we discussed below are all “bit value numerical systems”, which is named as “numerical system” for short. All the numerals discussed herein are integers.

2.1.3 Numerical system has three factors: numerical bit I, numerical element collection Zi and weight Li.

a. Numerical bit I refers to the position of the numeral of each bit in the numerical system, and is represented by I (ordinal) from right to left, i.e., i=1, 2, 3, . . . indicates the first, second, third bits of said numeral.

b. Numerical element collection Zi refers to the collection formed by the “numeral elements” at the Ith place. In the same numerical system, the collectivity of different symbols at the same place of each numeral form the numerical symbol collection, and elements within said numerical symbol collections are called “elements of numerals”, and “numerical elements” for short. Hence, said numeral symbol collection is called “numerical element collection”.

The numerical element collection Zi varies or remains the same according to the different values of I.

The numerical elements in the numerical element collection Zi could be complex number or other various symbols. Numerical elements are represented by aj (a1, a2, a3,), and iaj represents the numerical element aj at the ith place (j is a natural number).

The radix Pi (Pi≧2 and Pi is natural number) of the numerical element collection Zi indicates the total number of the elements in the collection. It decides not only its own nature, but also the nature of all other numerals. The different values of Pi indicate the variation of the numerical element collection Zi. If the Pi of all the bits is the same, it is called “single radix”; otherwise, it is called “mixed radix”, and the corresponding numerical system is called “single numerical system” and “mixed numerical system”.

c. Weight Li indicates the bit value of the ith bit, and said bit value is called “weight Li’.

Li is real number (since the complex number collection is not an ordered entity, it is not adopted); different Li determine different bit values.

In the “theory of encoding”, the main characteristic of “encoding” lies in weight Li.

The common weight Li in practice uses the so-called “power weight” ₀i, i.e., make Li=Q⁽ⁱ⁻¹⁾, Qᵢ is a real number. For easy calculation, Qi is usually natural number. The common Li of each place is power weight, and is the geometric proportion Q numerical system. Q is called the “basic number” of numerical system power weight or the “basic number” of the numerical system. Different basic numbers Q determine that the Li are different, and thereby determine different numerical values. Generally, such numerical system is named as “Q-nary {Q}”.

Another commonly used weight uses “equal weights”, that is, the weights of the bits are equal.

2.2 Mixed Numerals and Mixed Numeral System

When the bits of the basic number Pi are the same in the numerical element collection Zi, Pᵢ=Pᵢ₊₁=P is called “single basic number”; when the Pi of the bits are different, it is called “mixed basic number”. The corresponding numerical system is called “single numerical system” or “mixed numerical system”.

When Q=2, 3, 10, the corresponding numerical systems are called “binary”, “ternary”, “decimal”, etc.

In a numerical system, when P=Q, natural numbers could be represented in a successive and unique form in said numerical system, and this is called “continuous numerical system” or “common numerical system”;

When P>Q, natural numbers could be successive, but they are sometimes represented in a plurality of forms, and this is called “repeated numerical system”;

When P<Q, natural numbers can only be represented in an intermittent form in said numerical system, and this is called “intermittent numerical system”

When the numerical element collection Zi includes numerical element 0, said corresponding numerical system is called “numerical system 0 inclusive”;

When all the numerical elements in the numerical element collection Zi is successive numerals, said corresponding numerical system is called “numerical system of integral segment”.

When the numerical element collection Zi includes both positive numerical elements and negative numerical elements, the corresponding numerical system is called “mixed numerical system”, and numerals in the mixed numerical system are called “mixed numerals”. Numerals having both positive numerical elements and negative numerical elements in the mixed numerals are called “pure mixed numerals”. In {Q*} numerals, numerals having both positive numerical elements and negative numerical elements are called “pure {Q* } numerals”; (the definition of {Q*} is in the next section)

When the positive and negative numerical elements in the numerical element collection Zi are opposite numerals, the corresponding numerical system is called “symmetrical numerical system”; obviously, “symmetrical numerical system” is one of “mixed numerical system”.

2.3 Mixed Q-nary {Q*} and Common Mixed Q-nary {Common Q*}

In the □Theory of numerical system□, the name of a numerical system is “Zi Li”. For example, {0, 1, 2,} ternary or literal texts are used to indicate the characteristics of Zi.

As for common decimal, its name in the □Theory of numerical system□ is “decimal that is non-negative, asymmetrical and that is an integral segment, includes 0 and has single basic number P=10”. It can be written as {+, 0 inclusive, integral segment, non-negative} decimal, or as {0, 1, 2, . . . 9} decimal. Usually, it is further shortened as {+} which is called “common decimal”.

As for the common binary system, it is named in the □theory of numerical system□ as “single basic number P=2, 0 inclusive, integral segment, non-negative asymmetrical binary system”, and it could be written as {=, 0 inclusive, integral segment, non-negative} binary system, or as {0, 1} binary system. Usually, it is further shortened as {=} which is called “common binary system”.

There are mainly three types of mixed numeral numerical systems in the □mixed numeral, carry line method□ (□mixed carry method HJF□ for short, see the next section). In the □theory of numerical system□, their names are “single basic number P=19, 0 inclusive, integral segment, symmetrical decimal”, which could be written as {nineteen, 0 inclusive, integral segment, symmetric} decimal, or as {0, ±1, ±2, . . . ±9} decimal. Usually, it is further shortened as {+*} which is called as □mixed decimal□ (used for written calculation digital engineering, especially in textbooks about rational number operation). Or, “single basic number P=3, 0 inclusive, integral segment, symmetrical binary”, which could be written as {three, 0 inclusive, integral segment, symmetrical} binary, or as {0, ±1} binary. Usually, it is further shortened as {=*}, which is called □mixed binary□ (used for computer, etc.). Similarly, {0, ±1, . . . ±(Q−1)}Q is shortened as {Q} which is called □mixed Q-nary□.

In the mixed numeral numerical system, another type is common numerical system “Q, 0 inclusive integral segment, symmetrical Q-nary”, which is called as “0 inclusive, integral segment, symmetrical, common Q-nary” or as “common mixed Q-nary” (common Q*), wherein the typical one is { 1̅, 0, 1} ternary, which is called as “common mixed ternary” (common three*). [Note: −A is indicated by A̅, read as negative A, e.g., −1= 1̅, and the same below.] Obviously, in the common mixed Q-nary, Q can only be the odd number that is greater than 1.

In the 0 exclusive mixed numeral numerical system, one kind is common numerical system “Q, 0 exclusive, integral segment, symmetrical Q-nary”, which is called as “0 exclusive, integral segment, symmetrical, common Q-nary” or as “0 exclusive common mixed Q-nary” {0 exclusive common Q *}, wherein the typical one is { 1̅, 1} binary, which is called “0 exclusive common mixed binary” {0 exclusive common two*}. Obviously, in the 0 exclusive common mixed Q-nary, Q can only be positive even number.

Except the above-mentioned three types of “symmetrical mixed numeral numerical systems”, others symmetrical mixed numeral numerical systems are called “other symmetrical mixed numeral numerical systems”; and the other asymmetrical mixed numeral numerical systems are called “asymmetrical mixed numeral numerical systems”.

3. □Mixed Carry Method HJF□ and the Mixed Decimal {+*} Four Fundamental Operation Thereof.

The method that uses mixed numerals and □Method of carry line□ to perform rational number operation is called □mixed numeral, carry line method□, □mixed carry method HJF□ for short. When it is used in written calculation digital engineering, especially in textbooks about rational number operations, the □mixed carry method HJF□ of {+*} mixed decimal is adopted. When it is used in computer, etc., the □mixed carry method HJF□of {=*} mixed binary is adopted.

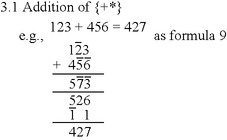

formula 9

In the formula, the sum is obtained as 5 7̅ 3̅. When there is the need to transform it into common decimal {+} numeral, the sum is 427.

Generally speaking, the obtained sum of 5 7̅ 3̅ does not need to be transformed (especially when it is used as the intermediate result in the computation process). When there is the need for transformation, the method is as shown in the transformation rules in 4.1.

3.2 Subtraction of {+*}

3.2.1 e.g., 1 2̅3−4 5̅ 6̅=1 2̅3+ 4̅56= 3̅39

First, it is transformed into addition for computing; this is determined by the characteristics of mixed numerals. In this way, in the real computation, addition and subtraction are combined into addition, thus the difficulty of successive addition and subtraction is eliminated.

e.g., 112 + 56 − 32 − 85 + 67 − 46 = 72

| | |
|---|---|
| 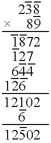 | 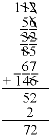 |
| formula 10 | formula 11 |

3.2.2 Reduction mixing. This refers to that when two numerals are added for the sum, the opposite numerals of the same bit could be canceled, which could also be called as “counterpart canceling” or “counterpart scratching”. In the formula, said two numerals could be scratched out by backlashes. In other words, “counterpart scratching” means that the sum of two opposite numerals is zero, and said two numerals at a certain bit do not participate in the operation any more.

3.3 Multiplication of {+*}
e.g., 2 3̅ 8̅×8 9̅=12 5̅02

3.4 Division of {+*}
e.g., 5728÷23=249 . . . 1

Key points: □ formula uses the original common division, but now the four fundamental uniformed formula as shown in formula 13 is adopted; □ in the formula, 57−23×2=57+ 2̅ 3̅×2=57+ 4̅ 6̅, that is to say, owing to the use of mixed numerals, the “subtracting” process in the division can be changed into “adding” process, and the rest are the same.

| | |
|---|---|
| 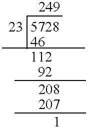 | 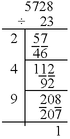 |
| formula 12 | formula 13 |

The clew of removing the process of “subtracting” makes the dividend to have a sign reversal, then the whole process of “subtracting” completely changes into “adding” process, thus the complexity of the whole operation is further reduced.

From now on, we use this method to perform division, but it should be noted that if arithmetical compliment appears at this time, the sign thereof should be reversed to obtain the arithmetical compliment of the final operation result.

4. The relationship between □mixed decimal□ {+*} and □common decimal□ {+}

4.1 Method of transformation between {+*} and {+} numerals

Integers are referred to herein, for example, {+*} 3 8̅ 2 2̅ 9̅ 6={+} 221716 (formula 1).

4.1.1 {+} numeral per se is one special case of {+*} numeral, so {+} numeral is just {+*} numeral without any transformation.

4.1.2 Transforming {+} numeral into {+*} numeral. There are two methods for such transformation: one is to change the {+*} numeral into a positive numeral and a negative {+} numeral and add them for the sum. This method varies, wherein the typical one is to take the positive numeral bits and the 0 bit in said {+*} numeral as a positive {+} numeral, while take the negative numeral bits as a negative {+} numeral.

For example, {+*}3 8̅ 2 2̅ 9̅ 6={+} 302006−20290=221716

Another method is that in {+*} numeral, the numeral segment of consecutive positive numerals (or 0) are written, as it is, for example, 3 x 2 x x 6. However, when it is not at the end (the units place) of the {+*} numeral, the lowest bit is added by 1̅; as for numeral segment of successive negative numerals, the sum of the reverse positive numerals of said negative numerals and the transformation numeral to be computed is made to be 9, e.g., x 1 x70 x, then the lowest bit thereof is added by 1.

In this way, the result is obtained to be 221716, which is the corresponding {+} numeral.

Thus the obtained numeral {+} 221716 is the result.

(Note: a line of subsection is added to the right of the negative numeral segment in the formula, but if there is no possibility of misunderstanding, the line of subsection may be omitted.)

| | |
|---|---|
| 0 = 0̅ = 00 = 000 = . . . = \dot{0} = 0₊ | 0̅ = 0̅ 0̅ = 0̅ 0̅ 0̅ = . . . = \dot{0̅} = 0₋ |
| 1 = 1̅ = 1 9̅ = 1 9̅ 9̅ . . . = 1\dot{9̅} | 1̅ = 1̅9 = 1̅99 = . . . = 1̅\dot{9} |
| 2 = 2̅ = 1 8̅ = 1 9̅ 8̅ . . . = 1\dot{9̅} 8̅ | 2̅ = 1̅8 = 1̅98 = . . . = 1̅\dot{9}8 |
| 3 = 3̅ = 1 7̅ = 1 9̅ 7̅ . . . = 1\dot{9̅} 7̅ | 3̅ = 1̅7 = 1̅97 = . . . = 1̅\dot{9}7 |
| 4 = 4̅ = 1 6̅ = 1 9̅ 6̅ . . . = 1\dot{9̅} 6̅ | 4̅ = 1̅6 = 1̅96 = . . . = 1̅\dot{9}6 |
| 5 = 5̅ = 1 5̅ = 1 9̅ 5̅ . . . = 1\dot{9̅} 5̅ | 5̅ = 1̅5 = 1̅95 = . . . = 1̅\dot{9}5 |
| 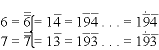 | 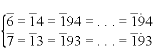 |
| 8 = 8̅ = 1 2̅ = 1 9̅ 2̅ . . . = 1\dot{9̅} 2̅ | 8̅ = 1̅2 = 1̅92 = . . . = 1̅\dot{9}2 |
| 9 = 9̅ = 1 1̅ = 1 9̅ 1̅ . . . = 1\dot{9̅} 1̅ | 9̅ = 1̅1 = 1̅91 = . . . = 1̅\dot{9}1 |
| 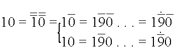 | 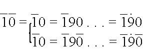 |
| 11 = 1̅ 1̅ = 11 = 1 9̅ 1̅ . . . = 1\dot{9̅}1 | 1̅ 1̅ = 1̅1 = 1̅9 1̅ = . . . = 1̅\dot{9} 1̅ |

Notes:
in the table, 9̅ indicates the quadratic negative of 9 (those more than quadrate are omitted), and the same is true with the other numerals.
□ In the formula, 0₊ and 0₋ are respectively 0 obtained by approaching 0 from the positive and negative directions.
□ In the formula, \dot{9} indicates 9 which is one of the consecutive random non-negative integral bit, which is read as “extended 9”. Tn the formula, 0 indicates 0, which is one of the successive random non-negative integral bits, which is read as “extended 0”. Such numerals could be called as “infinite extended numerals”.
□ There are only four kinds of infinite extended numerals, i.e., (\dot{0̅} □ \dot{0} □ \dot{9̅} □ \dot{9}). Since \dot{0̅} = \dot{0}, there are only three kinds of infinite extended numerals, i.e., (\dot{9̅} □ \dot{0} □ \dot{9}), which could also be written as (\dot{0} □± \dot{9}).
□ 0̅ = 0, this could be learnt from the two kinds of expression of 10, so 0̅ = 0 = \dot{0̅} = \dot{0}.

4.3 Analysis of relationship between {+*} an d {+}

4.3.1 {+} numeral is part of {+*} numeral, and the {+} numeral aggregate is the subset of {+*} numeral aggregate;

{+*} numeral ⊃ {+} numeral, that is, {+*} numeral include {+} numeral.

4.3.2 The relationship between the {+} numeral and the {+*} numeral is “one to many correspondence” instead of “one to one correspondence”. Because of this, {+*} has the flexibility of diversified processing, and this explains for the diversity and rapidity of {+*} operation. From this point of view, {+*} has more powerful functions.

4.3.3 When {+*} numeral is transformed into {+} numeral, it can only be transformed into a unique corresponding numeral, this is because that {+*} numeral can be obtained by adding and subtracting of {+} numeral, while the result of the addition and subtraction operations of {+} numeral is unique. Contrarily, {+} numeral can only be transformed into the unique corresponding set of {+*} infinite extended numerals, too. Therefore, the relationship between the “one” of {+} numeral and the “one” set of {+*} infinite extended numerals is the “one to one correspondence”.

Thereby, the relationship that the {+*} numeral and the {+} numeral are mapping to each other is established.

Since the transformation is the correspond acne from the set to itself, therefore, {+} numeral and {+*} numeral are “one to one transformation”. As for the operation system, {+} and {+*} numeral systems are “automorphism”. All the operational characters corresponding to the {+} numeral are also valid in the {+*} numeral system.

4.3.4 In {+*}, P>Q, so in said numerical system, the natural numerals sometimes manifest themselves in many forms, and this is the reason why said numerical system is flexible. It makes the operation simple and fast. It is also justifiable to say that {+*} sacrifices diversity for flexibility.

In {+}, P=Q, so in said numerical system, natural numerals are expressed in the unique and successive form, so there is no diversity and thus the corresponding flexibility is lacking.

It can be said that the key of the present invention lies in this. With it, the □mixed carry method HJF□comes into existence, with it, the new technical solution of “written calculation digital engineering” comes into existence, and with it, the new technical solution of computer comes into existence.

4.3.5 It should be pointed out that obviously, the above analysis on {+} and {+*} is completely corresponding to the analysis on {Q} and {Q *}, because {+} and {Q} are isomorphic. It can be seen that □ the relationship between the {Q} numeral and {Q *} numeral is “one to many correspondence” instead of “one to one correspondence”; □ meanwhile, the relationship between “one” numeral in {Q} and “one” set of infinite extended numerals in {Q *} is “one to one correspondence”; □ {Q} and {Q *} numeral systems are “automorphism”. All the operational characters corresponding to the {Q} numeral system are also valid in the {+*} numeral system.

5. Mixed Q-nary {Q *} and the application of □mixed carry method HJF□

5.1□Mixed carry method HJF□is an excellent operational method.

The theories and practices of □mixed carry method HJF□ prove that it closely associates the mixed numerals with the “Method of carry line” to make them complementary and to promote each other, so the effects are greatly enhanced. Therefore, the four fundamental operations of + − × and ÷ are fully and systematically improved. As an extraordinarily excellent method, the □mixed carry method HJF□will surely be used widely.

6. Conclusion

In summary, there are the following concise conclusions:

□ Mixed Q-nary {Q *} and □mixed carry method HJF□ could greatly increase the speed of operation in rational number operations, and they could notably decrease the error rate of written calculation.

Part II Mixed Q-nary and carry line processor

Four arithmetic operations are the basis for all operations, and it is obviously the basis for computer.

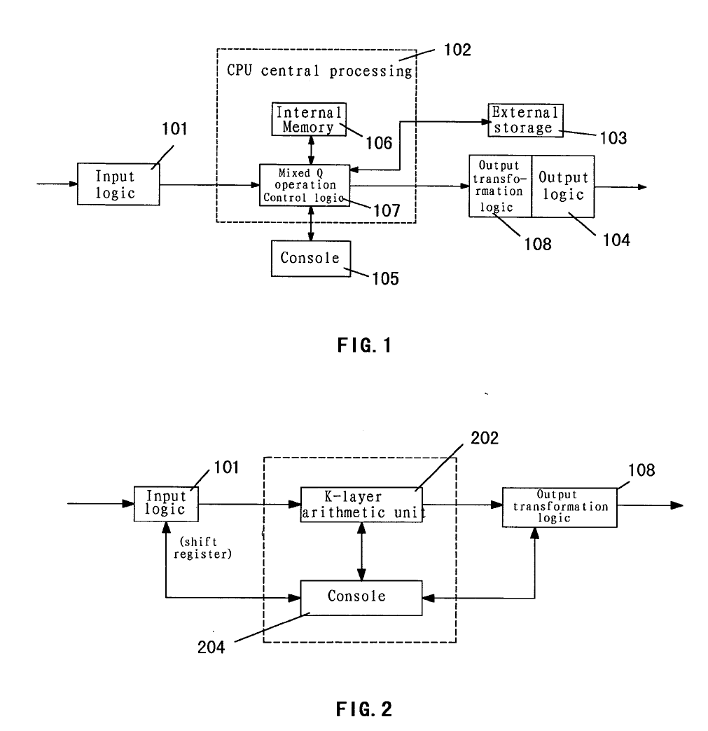

FIG. 1 is the general logic block diagram of the mixed Q-nary computer of the present invention. It is composed of the input logic 101, CPU central processing unit 102, external storage 103, output logic 104, console 105, and output transformation logic 108. The CPU 102 is composed of the memory 106 and mixed Q operation control logic 107. The connection relations among these components are known in the art. Wherein the common Q-nary numerals are input to the CPU 102 through the input logic 101, and mixed Q operation is performed through the mixed Q operation control logic 107, the result of operation is connected to the output transformation logic 108, and the result is output through the output logic 104 in the form of mixed Q-nary numeral or Q-nary numeral. The memory 106 and external storage 103 exchange data with the operation control logic 107 to execute the original common Q-nary program. The general operation is controlled by the console 105 to be realized according to predetermined program in the form of clock pulse.

FIG. 2 is the logic block diagram of the operation control, which comprises the input logic 101, k-layer arithmetic unit 202, output transformation logic 108 and controller 201.

The mixed Q-nary numeral is input to the k-layer arithmetic unit 202 via the shift register input logic 101; in the k-layer arithmetic unit 202, the mixed Q-nary numeral obtains the results thereof through the k-layer operations, and the results are output by the output transformation logic (decoder) 108 in the form of Q-nary numerals or mixed Q-nary numerals or common decimal numerals through the output logic 104, the controller 204 coordinates the logic of the entire operation controller.

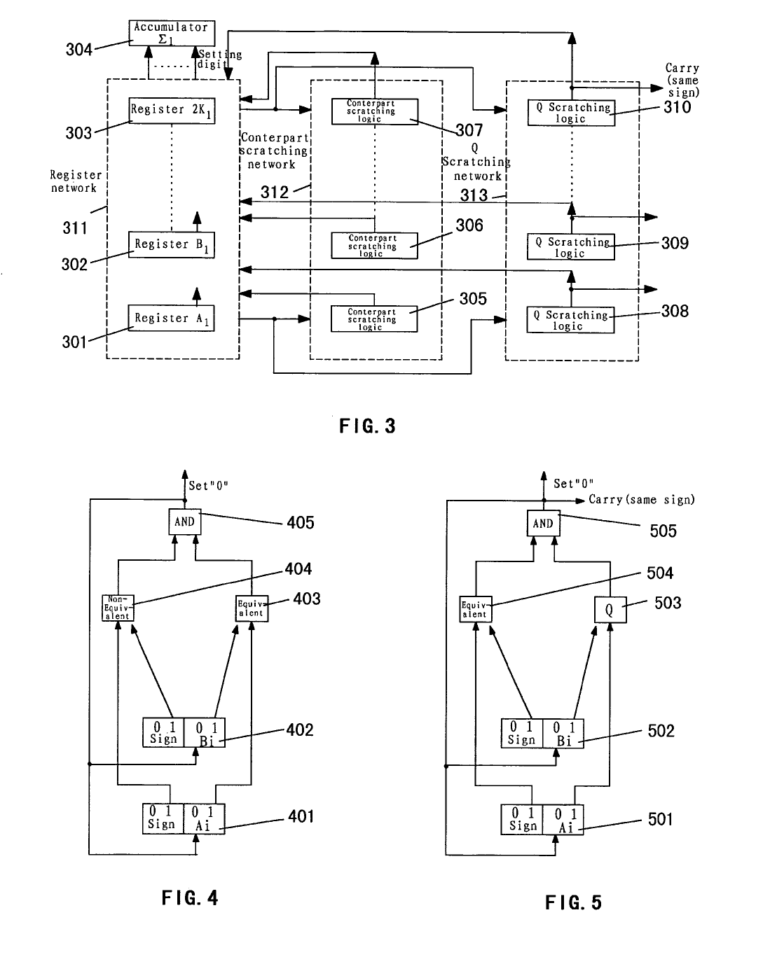

FIG. 3 is the logic block diagram of the k-layer arithmetic unit, which comprises the register network 311, counterpart scratching network 312, scratching Q network 313 and accumulator 304, wherein the accumulator (304) is a common accumulator with each bit having a positive and a negative sign, or each bit of the accumulator could also be assigned with a sign bit from the bit sign register. The register network 311 is composed of A register 301, B register 302, . . . 2K register 303. The counterpart scratching network 312 is inspected by a counterpart scratching logic 305, or it is formed by connecting K(2K−1) counterpart scratching logic 305, counterpart scratching logic 306, . . . , counterpart scratching logic 307 to the registers in the register network 311 two by two, or it is formed by grouped and graded counterpart scratching logic. The scratching Q network 313 is inspected by a scratching Q logic 310, or it is formed by connecting K(2K−1) scratching Q logic 308, scratching logic 309 . . . scratching logic 310 to the registers in the register network 311 two by two; or it is formed by grouped and graded scratching Q logic.

The register network 311 and the counterpart scratching network 312 and the scratching Q network 313 forms the “K-layer arithmetic unit”.

In said “K-layer arithmetic”, when the value of K is large, it can be processed by graded amplification.

In the 2K registers, the former K registers stores the input K mixed Q numerals. There is a sign bit before each register and each bit of the accumulator, said sign bit is the common two-state trigger. There is only one accumulator for storing the accumulated sum. There is a sign bit before each bit of the accumulator which is the common two-state trigger. The sign bit can also be placed in the special sign bit register, and during operation, the sign bit is assigned to the register for storing the mixed Q numeral or each bit of the accumulator. The latter K registers store the carry line numerals to form k carry lines.

If counterpart scratching and scratching Q are not adopted, then in the operation process, a certain bit of the two registers thereof is accumulated by the accumulator to obtain the sum of said bit and the carry to the higher bit, wherein the carry is sent to the adjacent higher bit of any one of carry line registers; when the next operation instruction arrives, the carry line and the originally stored numerals are sent to the accumulator to added.

This process is repeated and finally the sum is obtained by the accumulator.

In order to increase the operation speed, the counterpart scratching network and scratching Q network could be adopted. The controller or program sends instructions to first perform operations of “counterpart scratching” and “scratching Q”, and then accumulation operation is performed.

The carry generated by scratching Q is sent to the putting “1” end of the adjacent higher bit of any carry line register in the K-layer arithmetic unit.

FIG. 4 is the counterpart scratching logic (counterpart scratcher), which is composed of the ith bit 401 of register A, the ith bit 402 of register B, equivalent logic 403, non-equivalent logic 404 and AND gate 405, wherein a sign bit is attached before the ith bit 401 of register A, which is a common dimorphic trigger, wherein the “1” end of Ai is connected to the input of the equivalent logic 403, and the “1” end of the Ai sign is connected to the input of the non-equivalent logic 404.

A sign bit is attached before the ith bit 402 of the register B, which is a common dimorphic trigger, wherein the “1” end of Bi is connected to the input of the equivalent logic 403, and the “1” end of the Bi sign is connected to the input of the non-equivalent logic 404. The output of the equivalent logic 403 is connected to the input of the AND gate 405; the output of the non-equivalent logic 404 is connected to the input of the AND gate 405; and the output of the AND gate 405 is connected to the setting “0” end of the ith bit 401 of register A and the setting “0” end of the ith bit 402 of register B.

FIG. 5 is the scratching Q logic (Q scratcher), which is composed of ith bit 501 of register A, the ith bit 502 of register B, Q value decision logic 503, equivalent logic 504 and AND gate 505, wherein a sign bit is attached before the ith bit 501 of register A, which is a common dimorphic trigger. The “1” end of Ai is connected to the input of the Q value determination logic 503, and the “1”end of the Ai sign is connected to the input of the equivalent logic 504.

A sign bit is attached before the ith bit 502 of register B, which is a common dimorphic trigger. The “1” end of Bi is connected to the input of the Q value decision logic 503; the “1” end of the Bi sign is connected to the input of the equivalent logic 504; the output of the Q value determination logic 503 is connected to the input of the AND gate 505; the output of the equivalent logic 504 is connected to the input of the AND gate 505; the output of the AND gate 505 is connected to the setting “0” end of the ith bit 501 of register A and the setting “0” end of the ith bit 502 of register B.

When using {two*} for operation (the other mixed numerical systems are similar), in the operation and control, the three states of { 1̅, 0, 1} are adopted, wherein the positive and negative signs of 1̅ and 1 are indicated by one bit of {two} sign, and the weight thereof is 0.

When adopting {Q*} operation, the input of the arithmetic unit does not need to transform the {Q} numeral into {Q*} numeral, because {Q}.numeral is just the {Q*} numeral. That is, {Q*} numeral={Q} numeral+pure {Q*} numeral. On the other hand, the output of the arithmetic unit also does not need to transform the {Q*} numeral into {Q} numeral in the general intermediate process. Only when there is the need to output the final result, the {Q*} numeral is transformed into {Q} numeral (the substance is that only the pure {Q*} numeral is transformed into {Q} numeral). At this time, only a very simple decoder for transforming {Q *} numeral into {Q} numeral needs to be added on the output interface of the “operation” numerals in the computer of the present invention, and there is no technical difficult in this. Theoretically, the external storage and input and output of the computer of the present invention are completely the same as the prior art {Q} computer (including the programs), and the reason is that all the {Q} numerals are themselves included by the {Q*} numerals. In this sense, the modern {Q} numeral system computer is originally a special case of {Q *} computer.

In the computer system of the present invention, the “multi-layer arithmetic unit” is adopted. For example, “8-layer arithmetic unit” is adopted. The so-called “8-layer arithmetic unit” is putting 8 numerals into 8 registers to finish the adding and subtracting operations at one time. Suppose that the multiple numeral is K, and it is preferable that K=2ⁿ·5^{m} (n, m are non-negative integers). Since {two} and {ten} are commonly used, K=2, 4, 8, 16, 32, 64, 128 . . . and K=10, 20, 40, 80, 160 . . . and K=50, 100, 200 . . . The more important possibility is K=8, 10, 16, 20, 32, 40, 50, 64, 80, 100. Meanwhile, multiplication substantially is successive addition, and division substantially is successive subtraction, so in multiplication and division, the computer of the present invention could also use multi-layered multiplication and division in processing.

In addition to using the common accumulator in operation, the computer of the present invention can also use the “counterpart scratching” and “scratching Q” logic for speeding up the operation. “Counterpart scratching” means two opposite numerals are added and the sum is zero. As for “scratching Q” on a certain bit, it means that when two numerals of Q-nary are added, the sum of addition by bit ⊕ on a certain bit is zero but a carry is produced (whose sign is consistent with those of the two numerals). “Counterpart scratching” and “scratching Q” logic wiring is simple and mature in technique. See FIGS. 4 and 5.

In particular, in {two*} computer, the operation result can be obtained only by “counterpart scratching” first and then “scratching two”. Only when the final result needs to be output, the {two *} numeral is transformed into {ten} numeral.

### SUMMARY

I. The computer of the present invention is mixed Q-nary computer of {Q * } and is the computer of □mixed carry method HJF□.

II. The computer of mixed Q-nary {Q*} greatly improves the operation speed of various computers based on other principles at present and in the future. Take the 8 layer arithmetic unit as an example, it is coarsely estimated that it could increase the operational speed by 5 times, in other words, the former speed of 200000 times/s is increased to 1000000 times/s; and the former speed of 2 billion times/s is increased to about 10 billion times/s.

Part III

1. Enhanced Q-nary {Q^{Δ}} and all one code

1.1 Definitions and symbols [all the numerals in this text whose numerical systems are not indicated are common decimals, the same below].

In a numerical system, all the scales of P=Q+1>Q are called “enhanced Q-nary” indicated by the symbol {Q^{Δ}}. Obviously, {0, 1, 2} binary is “enhanced binary {two^{Δ}}; { 1̅, 0, 1} binary is both mixed binary {two *} and “enhanced binary {two^{Δ}} ”. In addition, there are other {two^{Δ}}.

1.2 Enhanced one-nary {one^{Δ}} and the operation thereof

In the enhanced Q-nary {Q^{Δ}}, when Q=1, it is enhanced one-nary {one^{Δ}}. The enhanced one-nary {one^{Δ}} mainly includes two types, one is {0, 1} one-nary, whose element device is a two state device. It is the earliest bit value numerical system appeared in human history, which represents numerals by the two states of “existence” and “nonexistence” of object; the other is { 1̅, 1 } one-nary, whose element device is also a two-state device, and it could represent all the integers. The document only analyzes {0, 1} one-nary.

Operation of enhanced one-nary {one^{Δ}}. Addition operation is listed herein, for example, {+} 4+3+2==9==
{one^{Δ}} 140101+4011+401=11001100040404011.

1.3 The relationship between enhanced one-nary {oneΔ} and {Q}.

1.3.1 Method of transforming between {oneΔ} numeral and {Q} numeral.

When transforming {one^{Δ}} numeral into {Q} numeral, the numeral 1 of each bit of the {one^{Δ}} numeral is counted by {Q}, and the obtained {Q} counting sum is the corresponding {Q} numeral. That is, the numerical value of {Q} numeral is equal to the number of 1 in the {one^{Δ}} numeral. Obviously, this is a very simple principle.

When transforming {Q} numeral into {one^{Δ}} numeral, each bit of the {Q} numeral is multiplied by the weight of each bit, and then the products are listed by non-repetitive manner with the same number of 1 on the positions of the {one^{Δ}} numeral to be represented. That is, the number of 1 in the {one^{Δ}} numeral is equal to the numerical value of the {Q} numeral. Obviously, this is also a very simple principle.

1.3.2 Comparison table of {one^{Δ}} numeral and {Q} numeral and the explanations thereof

In Tables 1 and 3 (make Q=2, 10)

In Tables 2 and 4 (make Q=2, 10)

| {ten} | {two} | {one^{Δ}} | {one^{Δ}} | {two} |
|---|---|---|---|---|
| | | | 000 | 0 |
| 0 | 000 | 0 . . . 00000000 = \dot{0} = 0 | 001 | 1 |
| 1 | 001 | 0 . . . 00000001 = 1 = 1\dot{0} | 010 | 1 |
| 2 | 010 | 0 . . . 00000011 = 11 = 11\dot{0} = 1\dot{0}1 = 1\dot{0}1\dot{0} = . . . | 011 | 10 |
| 3 | 011 | 0 . . . 00000111 = 111 = 111\dot{0} = 11\dot{0}1 = 11\dot{0}1\dot{0} = . . . | 100 | 1 |
| 4 | 100 | 0 . . . 00001111 = 1111 = 1111\dot{0} = 111\dot{0}1 = 111\dot{0}1\dot{0} = . . . | 101 | 10 |
| 5 | 101 | 0 . . . 00011111 = 11111 = 11111\dot{0} = 1111\dot{0}1 = 1111\dot{0}1\dot{0} = . . . | 110 | 10 |
| 6 | 110 | 0 . . . 00111111 = 111111 = 111111\dot{0} = 11111\dot{0}1 = 11111\dot{0}1\dot{0} = . . . | 111 | 11 |

| | | | |
|---|---|---|---|
| 7 | 111 | 0 . . . 01111111 = 1111111 = 1111111\dot{0} = 111111\dot{0}1 = 111111\dot{0}1\dot{0} = . . . | = = = = |
| | = | = = = | 1.2 [symbol] |

1.2 Table 2 (Q = 2)

| | | | | | | | | | | | | |
|---|---|---|---|---|---|---|---|---|---|---|---|---|
| | | | | | | | 1 | | | | | |
| | | | | 1 | | | | 1 | | | | |
| | | | 1 | | | 2 | | | 1 | | | |
| | 1 | | 3 | | | | 3 | | | 1 | | |
| 1 | | 4 | | | 6 | | | 4 | | | 1 | Yang Hui Triangle |
| | | | . | | | | | . | | | | |
| | | | . | | | | | . | | | | |

| {ten} | {0, 1} | {1} = {0, 1} − {+} | |
|---|---|---|---|
| | | 0000 | 0 |
| 0 | 0 = \dot{0} | 0001 | 1 |
| 1 | 1 = 1 = 1\dot{0} = . . . | 0010 | 1 |
| 2 | 11 = 11\dot{0} = . . . 1\dot{0}1\dot{0} = . . . | 0011 | 2 |
| 3 | 111 = 111\dot{0} = . . . 11\dot{0}1\dot{0} = . . . | 0100 | 1 |
| 4 | = | 0101 | 2 |
| 5 | | 0110 | 2 |
| 6 | = | 0111 | 3 |
| 7 | | 1000 | 1 |
| 8 | = | 1001 | 2 |
| 9 | 111111111 = 111111111 = . . . 111111111\dot{0} = . . . | 1010 | 2 |
| 10 | 1111111111 = 1111111111 = . . . = 1111111111\dot{0} = . . . | 1011 | 3 |
| = | = | 1100 | 2 |
| = | = | 1101 | 3 |
| = | = | 1110 | 3 |
| | | 1111 | 4 |
| Table 4 | | Table 3 | |

Notes:
{one^{Δ}} numeral can represent all the {Q} numeral
There are may repetitive numerals, for example, in four-bit {one^{Δ}} numeral, except that 0 and 4 are unique, the rest numerals all have repetitive numerals, wherein 1 has four repetitive numerals, 2 has six repetitive numerals, 3 has four repetitive numerals. Thus the numbers of repetitive numerals from 0 to 4 are 1, 4, 6, 4, 1.
This is consistent with the expansion coefficient C^{k}ₙ of binomial. (The number of bits n is natural numeral, and k is 0˜n.)
The 0 in the table indicates the consecutive 0 of any non-negative integral bit, which is the same as in the mixed Q-nary and is called as “infinite extended numeral”. In {one^{Δ}}numeral, there is but only one infinite extended numeral, i.e., “0”.

1.3.3 Analysis of the relationship between {oneΔ} and {Q}

1.3.3.1 Q⊃1, Q is natural numeral; 1 is the smallest natural numeral and is also the most basic natural numeral unit. Q includes 1, thus making the corresponding {Q} and {one^{Δ}} to have natural assocation.

1.3.3.2 The relationship between {Q} numeral and {one^{Δ}} numeral is “one to many correspondence” instead of “one to one correspondence”. Owing to this, {one^{Δ}} is endowed with the flexibility of diversified processing. This is one of the reasons for the rapidity of {one^{Δ}} operation. From this point of view, {oneΔ} has more powerful functions.

1.3.3.3 When {one^{Δ}} numeral is transformed into {Q} numeral, it can only be transformed into a corresponding unique numeral, this is because that the {one^{Δ}} numeral can be directly obtained through addition and subtraction, while the result of {Q} numeral after addition and subtraction is unique. On the contrary, {Q} can only be transformed into the corresponding unique set of {one^{Δ}} infinite extended numerals. Hence, the relationship between the “one” of {Q} numeral and the “one” set of {one^{Δ}} infinite extended numerals is “one to one correspondence”. Thereby, the relationship that the {one^{Δ}} numeral and the {Q} numeral are mapping to each other is established. As for the operation system, {Q} and {one^{Δ}} numeral systems are “automorphism”. All the operational characters corresponding to the {Q} numeral are also valid in the {one^{Δ}} numeral system.

1.3.3.4 In {one^{Δ}}, P=Q+1 Q, so in said numerical system, the natural numerals sometimes manifest themselves in many forms, and this is the reason why said numerical system is flexible. It makes the operation simple and fast. It is also justifiable to say that {one^{Δ}} sacrifices diversity for flexibility.

In {Q}, P=Q, so in such kind of numerals, natural numerals are expressed in the unique and consecutive form, so there is no diversity and thus the corresponding flexibility is lacking.

1.3.3.5 The above-mentioned {one^{Δ}} is combined with {Q *} and enhances the function. In view of {one^{Δ}}→{Q}→{Q *}, there is inherent associations there between, obviously, these are all within expectation.

1.4 Application of enhanced one-nary {one^{Δ}}

1.4.1 The operation of enhanced one-nary {one^{Δ}} is an excellent operation. Since it forms numerals by mating 0 to the unit 1 whose weight is 1, the operation thereof is usually realized by “delivery”. As for the carry in the operation of {one^{Δ}} numeral, it could be realized by the scratching Q logic in which the sum of addition by bit of the two numerals of the present bit is 0 and the carry is Q. The realization of such “delivery” and “scratching Q” logic requires only a very simple structure, but the speed is extraordinarily fast. This is another reason for the rapidity of operation of {one^{Δ}} numeral.

When the {one^{Δ}} numeral and the pure {Q*} numeral are combined in operation, a logic of “counterpart scratching” with simpler structure and faster speed is added, and this is the third reason for the rapidity of operation of {one^{Δ}} numeral.

1.4.2 the combination of {one^{Δ}} and {Q} can be used as the technical solution of the new generation ultrahigh speed computer. [See the next section for details]

2. All one-nary, all one numeral and all one code

2.1 All one-nary and all one numeral

The diversity of the enhanced one-nary {one^{Δ}} numeral is one of the reasons for the rapidity of the operation of {one^{Δ}} numeral. During multi-layer operations of {one^{Δ}} numeral, in the operation processes that do not need to obtain the final result, each layer of data generated is stored in the corresponding multi-layer register as the intermediate result.

However, since {one^{Δ}} numeral is extremely diversified, it is usually hard to ascertain the operation form of the numerals. Thus in general cases, it is necessary to add some restrictive condition to the {one^{Δ}} numeral to reduce the diversity thereof. Therefore, the “all one-nary” is produced.

In the positive integers of the enhanced one-nary {one^{Δ}}, each set of infinite extended numerals is limited to be chosen from the units place to start, and is represented in, and the unique form of successively arranging 1 from right to left. For example, {+} numeral 3={one^{Δ}} numeral 111/1110/1101/ . . . (/ means “or”) is defined as {+} 3={one^{Δ}} 111. Thus the repetitive numerals in each set of infinite extended numerals are deleted and only the exclusive form of all being 1 is left, which we called “all one numeral”. The scale expressing the all one numeral is called “all one-nary”. In tables 2 and 4, the left forms of {one^{Δ}} are “all one-nary” numerals.

Therefore, “all one-nary” is “enhanced one-nary” {one^{Δ}} limited by a specific condition.

2.2 All one code

All one-nary obviously has the following advantages and disadvantages. Advantages are: □ fast operation speed, “overturn” is replaced by “delivery”; □ during multi-layer operation, it is no longer necessary to get the sum two by two, and the result can be obtained by “counterpart scratching” and “scratching Q”, thus the general operational speed is greatly improved; □ the transformation between it and {Q} is convenient. Disadvantages are: □ too long “word length” and too many bits; □ small amount of loaded information. Therefore, by exploiting the advantages and avoiding the disadvantages, it is suitable to encode {Q} by the all one-nary. Encoding by the “all one-nary” is called “all one encoding”. The “all one numeral” adopted in “all one encoding” is called “all one code”. Table 1 shows the situation of encoding {two} numerical element by one bit of the all one code. It can be seen from table 1 that the {two} numeral encoded by one bit of the all one code is the {two} numeral per se. Table 2 shows the situation of encoding {ten} numerical element by nine bits of the all one code. It can be seen from table 2 that in the {ten} encoded by nine bits of the all one code, the word length increases 9 times.

| All one code | {two} numerical element | all one code | {ten} |
|---|---|---|---|
| 0 | 0 | 0 | 0 |
| 1 | 1 | 1 | |
| | | 11 | |
| | | === | |
| | | 111111111 | 9 |
| 2.2 Table 1 | | 2.2 Table 2 | |

For example, {ten} 23 = all one code = =.

As for mixed Q-nary {Q *}, it can be encoded by the all one code plus the sign bits. In particular, the {two *} numeral encoded by one bit of the all one code is the {two *} numeral per se; and the {two *} numeral is encoded by the all one code plus the sign bit.

2.3 Calculation of all One Code

The calculation of all one code is very simple. Take the addition of two numerals as an example, it is merely the non-repeated arrangement of 1 of the two numerals, which is named as “arranging 1” for short. For example, 11+111=11111.

2.4 Application of All One Code

The all one code is mainly applied to encoding {Q} and {Q *} numeral, in particular,

□ by using the 9 bits of the all one code to encode {ten} numeral, the common decimal {ten} and all one code computer of the present invention can be realized.

□ by using the 9 bits of the all one code to encode {ten *} numeral, the mixed decimal {ten *} and all one code computer of the present invention can be realized.

□ by using the all one code to encode {Q *} numeral, the mixed Q-nary {Q *}, carry line and all one code computer of the present invention can be realized.

Part IV Mixed binary {two *}, carry line processor technical solution

The computer of the present invention is based on the {two} numerical system computer, and it changes the formerly used {two} numerical system into the {two*} numerical system which includes itself. It can be considered as a {two*} computer encoded by one bit of all one code plus the sign bit, and it named as mixed binary {two *} computer. The general logic block diagram of said computer is as shown in FIG. 1.

If the current computer is {ten} numerical system, then the formerly adopted {ten} numerical system is changed into the {ten*} numerical system which includes itself.

If the current computer is {Q} numerical system, then the formerly adopted {Q} numerical system is changed into the {Q*} numerical system which includes itself.

In the special computer having three-state storage or with small storage capacity, the computer of the present invention could be designed to use the numerical system of {Q*}, especially {two*}; or it is also possible to adopt another kind of numerical system of mixed numeral, i.e., odd number common numerical system like { 1̅, 0, 1) ternary of “0 inclusive, integral segment, symmetric” of numerical element collection.

The operation of the computer of the present invention adopts the □mixed carry method HJF□, that is, □mixed carry method HJF□of mixed binary {two *}, or □mixed carry method HJF□of mixed decimal {ten *}, or□mixed carry method HJF□of mixed Q-nary {Q *}.

On the other hand, the □mixed carry method HJF□of { 1̅, 0, 1} ternary can also be adopted, or the □mixed carry method HJF□of odd number common numerical system of other “0 inclusive, integral segment, symmetric” numerical element collection.

Part V common decimal {ten}, new generation technical solution for all one-code computer

(I) Said common decimal {ten}, all one code computer is a {ten} computer encoded by nine bits of the all one code on the basis of the {ten} computer.

(II) The general logic block diagram is as shown in FIG. 1.

When using the common decimal {ten} and all one code in operation, since said computer per se is the {ten} computer, both of the input and output of the arithmetic unit are inter-transformed with the {ten} numeral through the very simple all one code decoder, thus avoiding the problem of inter-transformation with the decimal {ten} numerals by 8421 encoding, etc. in the binary {two} computers. In human history, the width and depth of the application of {ten} calculation is beyond the reach of other scales. The long time accumulation of the civilization of human history and culture makes the {ten} have a solid incomparable position. Therefore, the {ten} all one code computer has special significance.

In the output transformation logic of FIG. 1, the {ten} numeral encoded by nine bits of the all one code is transformed by the all one code decoder into the {ten} numeral which is standard in form, When inputting the {ten} numeral, it is encoded by the all one code. This is a pretty mature computer technique.

(III) The common decimal {ten} and all one code computer uses the “scratching ten” logic to obtain the operation result. “Scratching ten” on a certain bit, means that when two decimal numerals are added, the sum of addition by bit ⊕ on a certain bit is zero, but a carry is produced. The “scratching ten” logic wiring is also simple and mature in technique.

Summary: common decimal {ten} and all one code computer can usually be used as special computer.

Part VI New generation technical solution of mixed decimal {ten *}, all one code computer

(I) Said mixed decimal {ten*}, all one code computer changes the formerly used {ten} numerical system into the {ten*} numerical system that includes itself on the basis of the {ten} computer.

(II) The mixed decimal {ten*}, all one code computer is the {ten *} computer encoded by nine bits of the all one code plus the sign bits.

(III) Operations in said computer adopt□mixed carry method HJF□, i.e., the □mixed carry method HJF□of mixed decimal {ten *}.

(IV) The general logic block diagram of the mixed decimal {ten *}, all one code computer is as shown in FIG. 1.

In the mixed decimal {ten*}, all one code computer, the {ten} numeral is encoded by nine bits of the all one code; and in {ten*} numeral, the nine bits of the all one code plus one sign bit {0, 1} are used to encode the input and output.

When using {ten*} in operation, the input of the arithmetic unit does not need to transform {ten} numeral into {ten*} numeral, because {ten} numeral is itself the {ten*} numeral, that is, {ten*} numeral={ten} numeral+pure {ten*} numeral. On the other hand, the output of the arithmetic unit also does not need to transform the {ten*} numeral into {ten} numeral in the general intermediate process. Only when there is the need to output the final result, the {ten*} numeral is transformed into {ten} numeral (the substance is that only the pure {ten*} numeral is transformed into {ten} numeral). At this time, only a very simple decoder for transforming {ten*} numeral into {ten} numeral needs to be added on the output interface of the “operation” in the computer of the present invention, and there is no technical difficulty in this. Theoretically, the external storage and input and output of the computer of the present invention are completely the same as the prior art {ten} computer (including the programs), and the reason is that all the {ten} numerals are themselves included by the {ten*} numerals. In this sense, the modem {ten} numeral system computer is originally a special case of {ten *} computer.

(V) In the mixed decimal {ten*}, all one code computer, the “multi-layer arithmetic unit” is adopted. For example, “eight-layer arithmetic unit” is adopted. The so-called “eight-layer arithmetic unit” is putting eight numerals into eight registers to finish the adding and subtracting operations at one time. Suppose that the multiple numeral is K, and it is preferable that K=2ⁿ·5^{m} n, m are non-negative integers). Since {two} and {ten} are commonly used, K=2, 4, 8, 16, 32, 64, 128 . . . and K=10, 20, 40, 80, 160 . . . and K=50, 100, 200 . . . The more important possibility is K=8, 10, 16, 20, 32, 40, 50, 64, 80, 100. Meanwhile, multiplication substantially is successive addition, and division substantially is successive subtraction, so in multiplication and division, the computer of the present invention could also use multi-layered multiplication and division for processing.

(VI) The mixed decimal {ten*}, all one code computer uses the “counterpart scratching” and “scratching ten” logic. “Counterpart scratching” means two opposite numerals are added and the sum is zero. As for “scratching ten” on a certain bit, it means that when two decimal numerals are added, the sum of addition by bit ⊕ on a certain bit is zero but a carry is produced (whose sign is consistent with those of the two numerals). “Counterpart scratching” and “scratching ten” logic wiring is simple and mature in technique. See FIGS. 4 and 5.

In particular, in {ten*}, all one code computer, the operation result can be obtained only by “counterpart scratching” first and then “scratching ten”. Only when the final result needs to be outputted, the {ten *} numeral encoded by the all one code is transformed into {ten} numeral to be output.

### SUMMARY

I. The {ten*}, all one code computer is mixed {ten*}, all one code computer and is the computer of □mixed carry method HJF□.

2. The {ten*}, all one code computer of the present invention greatly improves the operation speed of various computers based on other principles at present and in the future. Take the eight layer operation as an example, it is roughly estimated that it could increase the operation speed by more than five times, in other words, the former speed of 200000 times/s is increased to about 1000000 times/s; and the former speed of 2 billion times/s is increased to about 10 billion times/s.

What is claimed is:

1. A mixed Q-nary and carry line digital engineering method, comprising the following steps:
The first step, add a numeral sign to each bit of numeral of the common Q-nary numerals that participate in the operation, i.e., indicating if said bit of numeral is positive or negative, so as to make it become a mixed Q-nary numeral, suppose that the numerals that participate in the operation are k mixed Q-nary numerals:
The second step, perform a sum operation for k numerals at the same time, the operation starts from the lowest bit, and the numerals are added by bit, that is, at a certain bit, two numerals in said k numerals are taken to be added by bit, and a “sum by bit” is obtained, which is the sum of operation layer as the “partial sum” numeral, meanwhile, the obtained “mixed numeral scale” is stored at the higher bit adjacent to said bit in any carry line in the next operation layer;
The third step, chose other two numerals among the k numerals at said bit to perform the second step of operation, and repeat these steps until the k numerals are all taken; when there is only one numeral of the k numerals left, it is directly moved to the same bit at the next operation layer as the “partial sum” numeral;
The fourth step, at a higher bit adjacent to the above-mentioned certain bit, the operations of the second and third steps are repeated until all the operations of each bit of the k operational numerals are finished;
The fifth step, in the next operation layer, an operation for the sum as described in the previous second, third and fourth steps is performed for said “sum by bit” numeral and the “carry numeral” in the carry line;
The operations of the second to the fifth steps are repeated until no “mixed Q-nary” is produced, then the sum obtained in the last “adding by bit” is the result of the addition.

2. The mixed Q-nary and carry line digital engineering method according to claim 1, characterized by that at a certain bit, when performing sum operation for two numerals of the k numerals, if two numerals of said bit are opposite numerals, then the sum of said bit is zero, then a certain bit of said two operational numerals are set to be “0” in a logic manner and they will not participate in future operations; when performing sum operation for two numerals of the k numerals at a certain bit, if the sum of adding by bit of two numerals is zero, but the carry is produced, then the carry is put to the adjacent higher bit in any carry line, and a certain bit of said two operational numerals are set to be “0” in a logic manner and they will not participate in future operations.

3. The mixed Q-nary and carry line digital engineering method according to claim 1 or 2, characterized by that the mixed Q-nary numeral is encoded by all one code, that is, each bit of numeral S of the mixed Q-nary numerals is represented by 1 with the number of S arranged from the lowest bit to the higher bit, and the rest of the higher bits are all 0, and the total number of bits are (Q−1); meanwhile, the numeral sign of said bit, i.e., the sign indicating if the numeral of said bit is positive or negative, is used as the numeral sign of each bit in the corresponding all one code.

4. The mixed Q-nary and carry line digital engineering method according to any one of claims 1 to 3, characterized by that addition of two numerals is only the non-repeated arrangement of 1 of the two numerals.

5. The mixed Q-nary and carry line digital engineering method according to claim 1 or 2, wherein said operational numeral is mixed Q-nary numeral, Q is natural number.

6. The mixed Q-nary and carry line digital engineering method according to claim 1 or 2, wherein said operational numeral is common mixed Q-nary numeral, in particular common mixed ternary numeral.

7. The mixed Q-nary and carry line digital engineering method according to claim 1 or 2, wherein said operational numeral is numeral of the mixed numeral numerical system.

8. A mixed Q-nary and carry line processor, comprising input logic (101), K-layer arithmetic unit (202), output transformation logic (108) and controller (201); the mixed Q-nary numeral shift register inputs logic (101) to the K-layer arithmetic unit (202); in the K-layer arithmetic unit (202), a mixed Q-nary numeral result is obtained for the mixed Q-nary numeral after the K-layer operations, which is output by the output logic (104) through the decoder output transformation logic (108) in the form of Q-nary numeral or mixed Q-nary numeral, or common decimal numeral, the controller (201) coordinates and controls the logic of the entire operation controller; wherein,
each register of the 2K registers and each bit of the accumulator are assigned with a sign bit, said sign bit is a common two-state trigger; the former K registers store the inputted K mixed-Q numerals, while the latter K registers form the K carry lines;
During operation, a certain bit of two registers obtains the sum thereof and the carry for the higher bit after the accumulator accumulates them, and the carry is sent to the adjacent higher bit of any carry line register; when the next operation command arrives, the carry line and the originally stored numeral are sent to the accumulator to added;
such processes are repeated and finally the sum is obtained by the accumulator.

9. The mixed Q-nary and carry line processor according to claim 8, further comprising:
counterpart scratching network (312) and scratching Q network (313) connect to the register in the register network (311) two by two;
instructions sent by the controller or program first perform “counterpart scratching” and “scratching Q” operations on each numeral of the operational numerals at a certain bit, then perform accumulation operation; wherein the accumulator (304) is a common accumulator with each bit thereof having a positive or negative sign bit;
the “carry” produced by scratching Q at a certain bit is sent to the “1” end of the adjacent higher bit of the register of any carry line in the K-layer arithmetic unit.

10. The mixed Q-nary and carry line processor according to claim 9, wherein the counterpart scratching network (312) is inspected by the counterpart scratching logic (305), or it is formed by connecting the K (2K−1) counterpart scratching logic (305, 306 . . . 307) to the registers in the register network (311) two by two; or it is formed by grouped or graded counterpart scratching logic;
wherein the scratching Q network (313) is inspected by a scratching Q logic (310), or is formed by connecting the K (2K−1) scratching Q logic (308, 309 . . . 310) to the registers in the register network (311) two by two; or it is formed by grouped or graded scratching Q logic;
in said “K-layer arithmetic unit”, if the value of K is large, a graded amplification could be performed thereon.

11. The mixed Q-nary and carry line processor according to claim 10, wherein the counterpart scratching logic is composed of the ith bit (401) of register A, the ith bit (402) of register B, equivalent logic (403), non-equivalent logic (404) and AND gate (405), wherein a sign bit is attached before the ith bit (401) of register A, which is a common two-state trigger, wherein the “1” end of Ai is connected to the input of the equivalent logic (403), and the “1” end of the Ai sign is connected to the input of the non-equivalent logic (404); a sign bit is attached before the ith bit (402) of the register B, which is a common two-state trigger, wherein the “1” end of Bi is connected to the input of the equivalent logic (403), and the “1” end of the Bi sign is connected to the input of the non-equivalent logic (404). The output of the equivalent logic (403) is connected to the input of the AND gate (405); the output of the non-equivalent logic (404) is connected to the input of the AND gate (405); and the output of the AND gate (405) is connected to the setting “0” end of the ith bit (401) of register A and the setting “0” end of the ith bit (402) of register B.
wherein the scratching Q logic is composed of ith bit (501) of register A, the ith bit (502) of register B, Q value determination logic (503), equivalent logic (504) and AND gate (505), wherein a sign bit is attached before the ith bit (501) of register A, which is a common two-state trigger; the “1” end of Ai is connected to the input of the Q value determination logic (503), and the “1” end of the Ai sign is connected to the input of the equivalent logic (504); a sign bit is attached before the ith bit (502) of register B, which is a common two-state trigger; the “1” end of Bi is connected to the input of the Q value decision logic (503); the “1” end of the Bi sign is connected to the input of the equivalent logic (504); the output of the Q value decision logic (503) is connected to the input of the AND gate (505); the output of the equivalent logic (504) is connected to the input of the AND gate (505); the output of the AND gate (505) is connected to the setting “0” end of the ith bit (501) of register A and the setting “0” end of the ith bit (502) of register B.

12. The mixed Q-nary and carry line processor according to claim 8, wherein said operational numeral is represented by all one code.

13. The mixed Q-nary and carry line processor according to claim 8, wherein said operational numeral is mixed Q-nary numeral, and Q is natural number.

14. The mixed Q-nary and carry line processor according to claim 8, wherein said operational numeral is common Q-nary numeral.

15. The mixed Q-nary and carry line processor according to claim 8, wherein said operational numeral is numeral of the mixed numeral numerical system.
